(19) United States
(12) Patent Application Publication
(10) Pub. No.: US 2026/0296207 A1
(43) Pub. Date: Oct. 1, 2026

(54) ELECTRIC VEHICLE CONTROL DEVICE

(71) Applicants: Hino Motors, Ltd., Tokyo (JP); TOYOTA JIDOSHA KABUSHIKI KAISHA, Toyota-shi (JP)

(72) Inventors: Koichiro TANIGUCHI, Tokyo (JP); Hidetaka KUGIMOTO, Tokyo (JP); Yuki ASHINO, Tokyo (JP); Yuta OKAZOE, Tokyo (JP)

(73) Assignees: Hino Motors, Ltd., Tokyo (JP); TOYOTA JIDOSHA KABUSHIKI KAISHA, Toyota-shi (JP)

(21) Appl. No.: 19/557,935

(22) Filed: Mar. 5, 2026

(30) Foreign Application Priority Data
Mar. 28, 2025 (JP) 2025-056957

(51) Int. Cl. B60L 3/04; B60L 50/51

(52) U.S. Cl. CPC B60L 3/04; B60L 50/51; B60L 2210/40; B60L 2240/507

(57) ABSTRACT

An electric vehicle control device acquires a stop request signal that requests stopping of a battery system, executes stop processing of the battery system based on the stop request signal, and controls a transmission mechanism so that transition from a first state in which a motor and drive wheels are mechanically connected to a second state in which the motor and the drive wheels are mechanically disconnected is started prior to the execution of the stop processing of the battery system.

### CROSS-REFERENCE TO RELATED APPLICATIONS

This application is based upon and claims the benefit of priority from Japanese Patent Application No. 2025-056957, filed on Mar. 28, 2025, the entire contents of which are incorporated herein by reference.

### TECHNICAL FIELD

The present disclosure relates to an electric vehicle control device.

### BACKGROUND

An electric vehicle is known which is provided with a motor that is operated by electric power from a battery such as a fuel cell. For example, Japanese Unexamined Patent Publication No. 2004-282886 discloses a technology relating to a hybrid automobile that travels by power from an internal combustion engine and power from an electric motor. In this technology, when neutral is detected as a shift position, when a vehicle speed equal to or greater than a predetermined vehicle speed is detected, control is performed so that power from the electric motor is not transmitted to a drive shaft.

Japanese Unexamined Patent Publication No. 2011-207296 and Japanese Unexamined Patent Publication No. 2011-207295 disclose a technology in which a clutch is placed in a disconnected state when a system switch is on and a mode is a neutral mode, and the clutch is placed in a connected state regardless of the mode when the system switch is off and rotation of wheels is in a stopped state. Further, Japanese Unexamined Patent Publication No. 2017-140998 discloses a technology in which a rotating electric machine is shut down during neutral stopping in which neutral is selected as a shift range in a state in which the vehicle is stopped.

### SUMMARY

In an electric vehicle, electric power from a battery system is converted into an alternating current by a drive motor inverter and is supplied to a motor. In this configuration, in a state in which voltage is applied to the drive motor inverter, when an error occurs in control of the drive motor inverter, there is a possibility that torque is generated in the motor. In this case, it is conceivable that vehicle driving not intended by a driver occurs even during stop processing of the battery system.

The present disclosure describes a device that suppresses generation of driving force in a vehicle when stopping a battery system.

In the present disclosure, an electric vehicle control device that performs control of an electric vehicle is provided. The electric vehicle is provided with a battery system, an inverter that converts electric power from the battery system into an alternating current, a motor that is operated by the alternating current supplied from the inverter, and a transmission mechanism that transmits power of the motor to drive wheels. The transmission mechanism is controllable with respect to being brought into either a first state in which the motor and the drive wheels are mechanically connected or a second state in which the motor and the drive wheels are mechanically disconnected. The electric vehicle control device is provided with a processing circuit. The processing circuit acquires a stop request signal that requests stopping of the battery system. The processing circuit executes stop processing of the battery system based on the stop request signal. The processing circuit controls the transmission mechanism so that transition from the first state to the second state is started prior to the execution of the stop processing of the battery system.

In this electric vehicle control device, when stop processing of the battery system is performed, control is performed so that the motor and the drive wheels are mechanically disconnected prior to the stop processing of the battery system. Therefore, even if an error occurs in control of the inverter and the motor operates in a case where stopping of the battery system takes time or the like, transmission of power of the motor to the drive wheels is suppressed. Therefore, it is possible to suppress generation of driving force in the vehicle when stopping the battery system.

In an example, the processing circuit may execute the stop processing of the battery system without waiting for transition from the first state to the second state when there is an abnormality in the transition from the first state to the second state. In this configuration, even if a malfunction occurs in the transmission mechanism or a transmission state control unit, the stop processing of the battery system can progress without delay.

In an example, the processing circuit may determine that there is an abnormality in the transition from the first state to the second state when the transition from the first state to the second state is not completed even after a predetermined time has elapsed. In this configuration, since determination of abnormality is performed by the processing circuit, the stop processing of the battery system can proceed without delay.

In an example, the processing circuit may acquire a determination result of whether or not the electric vehicle is traveling, and may control the transmission mechanism so that transition from the first state to the second state is started after the electric vehicle stops when the electric vehicle is traveling. In this configuration, it is possible to suppress malfunctions due to the motor and the drive wheels being mechanically disconnected in the traveling electric vehicle.

According to one aspect of the present disclosure, it is possible to suppress generation of driving force in a vehicle when stopping a battery system.

### BRIEF DESCRIPTION OF THE DRAWINGS

FIG. 1 is a block diagram showing an electric vehicle in which an electric vehicle control device according to an example embodiment is mounted.

FIG. 2 is a diagram for explaining functions of an example electric vehicle control device.

FIG. 3 is a diagram showing an example of an operation flow of the electric vehicle control device.

### DETAILED DESCRIPTION

Hereinafter, exemplary embodiments will be described with reference to the drawings. In each drawing, identical or corresponding elements are assigned the same reference numerals, and duplicate description is omitted.

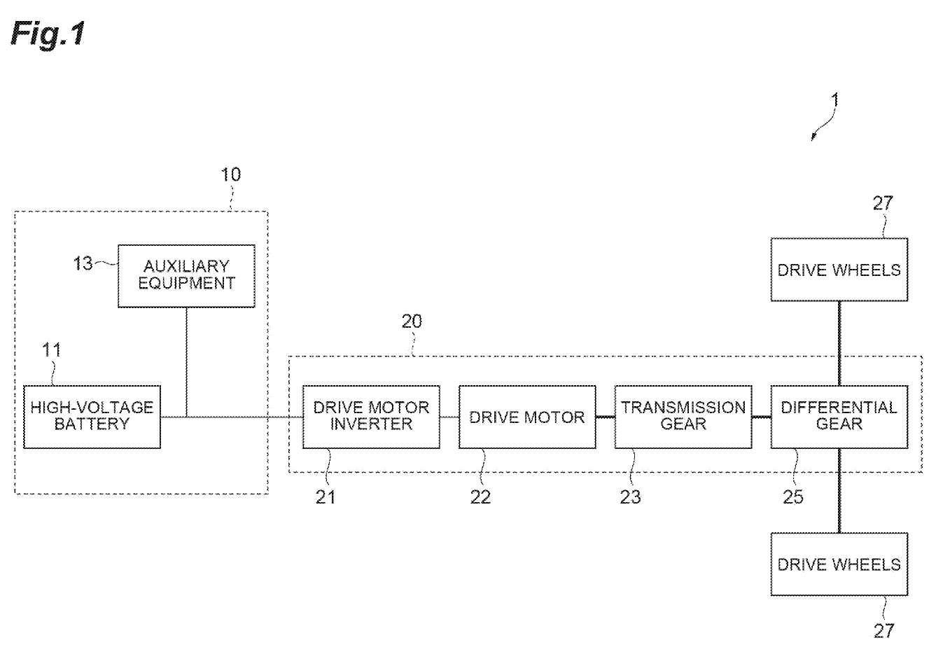

FIG. 1 is a block diagram showing an example electric vehicle. The electric vehicle 1 is, for example, a fuel cell electric vehicle (FCEV), a battery electric vehicle (BEV), a hybrid electric vehicle (HEV), a plug-in hybrid electric vehicle (PHEV), or the like.

The electric vehicle 1 includes a high-voltage system 10 (battery system) and a drive system 20. The high-voltage system 10 includes a high-voltage battery 11 and other auxiliary equipment 13. The high-voltage battery 11 is, for example, a secondary battery such as a lithium-ion secondary battery or a nickel-hydride secondary battery, and has a rated output voltage of 200 to 400 V. The high-voltage battery 11 may include a relay or the like for interrupting supply of electric power.

The auxiliary equipment 13 is an electronic device, an electrical component, or the like mounted on the electric vehicle 1. As one example, the auxiliary equipment 13 may be an automobile air conditioner, a headlight, a heater, or the like. The auxiliary equipment 13 is operated by electric power supplied from the high-voltage battery 11.

The drive system 20 includes a drive motor inverter 21, a drive motor 22, a transmission gear 23 (transmission mechanism), and a differential gear 25. The drive motor inverter 21 converts electric power from the high-voltage system 10 into an alternating current. As one example, the drive motor inverter 21 may be a three-phase bridge circuit having, for example, an insulated gate bipolar transistor (IGBT) and a diode.

The drive motor 22 is operated by the alternating current supplied from the drive motor inverter 21 and outputs driving force for traveling. The drive motor 22 is, for example, an AC synchronous type, and functions as an electric motor and also functions as a generator. The drive motor 22 has a rotor made of a permanent magnet and a stator around which a three-phase winding is wound.

The transmission gear 23 is connected to the rotor of the drive motor 22, and transmits power of the drive motor 22 to drive wheels 27 via the differential gear 25. The transmission gear 23 has, for example, a first gear stage used in a normal vehicle speed range and a second gear stage used in a vehicle speed range higher than the normal vehicle speed range. The gear ratio at the second gear stage is smaller than the gear ratio at the first gear stage. For example, the transmission gear 23 is controlled to the first gear stage in a normal state, and is switched to the second gear stage in order to prevent the drive motor 22 from over-rotating on a downhill slope or the like.

Such a transmission gear 23 is controllable between a first state in which the drive motor 22 and the drive wheels 27 are mechanically connected and a second state in which the drive motor 22 and the drive wheels 27 are mechanically disconnected. The first state is a state in which the transmission gear 23 is controlled to the first gear stage or the second gear stage, and the second state is a state in which the transmission gear 23 is controlled to neutral. Hereinafter, a state in which the drive motor 22 and the drive wheels 27 are mechanically disconnected, like the second state, may be called "mechanical neutral".

A control device 30 (electric vehicle control device) is a device that performs control of the electric vehicle 1. The control device 30 has a so-called electronic control unit (processing circuit) having a central processing unit (CPU), a read only memory (ROM), a random access memory (RAM), and the like. In such an electronic control unit, for example, various functions are realized by loading a program recorded in the ROM into the RAM and executing the program loaded in the RAM by the CPU.

The control device 30 may be divided into a first electronic control unit 30A that is electrically connected to the high-voltage system 10 and performs control of the high-voltage system 10, and a second electronic control unit 30B that is electrically connected to the drive system 20 and performs control of the drive system 20 (see FIG. 1). In this case, the first electronic control unit 30A and the second electronic control unit 30B may be connected so as to be able to communicate with each other.

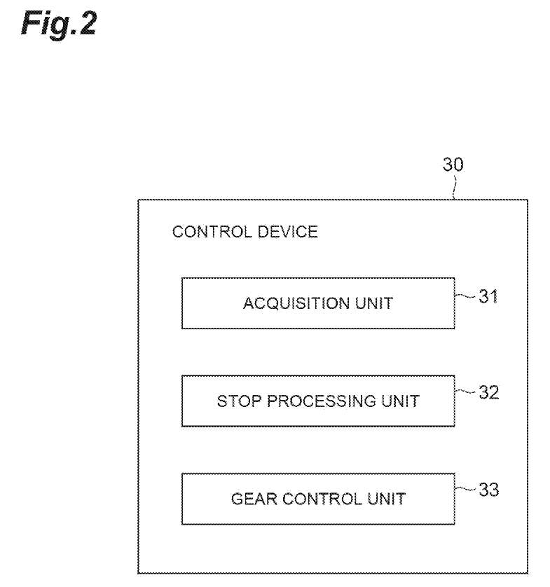

FIG. 2 is a diagram for explaining functions of an example control device. The control device 30 functionally has at least an acquisition unit 31, a gear control unit 33, and a stop processing unit 32. The control device 30 may further have various functional units for controlling traveling of the electric vehicle 1.

The acquisition unit 31 acquires a stop request signal that requests stopping of the high-voltage system 10. For example, the stop request signal is input to the acquisition unit 31 based on a key-off operation by a driver. Further, the stop request signal may be acquired by the acquisition unit 31 regardless of an operation (action) by the driver. For example, in one example, when it is determined that it is necessary to stop the high-voltage system 10 based on a result of a self-diagnosis function that detects an abnormality in each part of the electric vehicle 1 including the high-voltage system 10, the stop request signal may be input to the acquisition unit 31.

When the stop request signal is acquired by the acquisition unit 31, the gear control unit 33 controls the transmission gear 23 so that transition from the first state to the second state is started. That is, the gear control unit 33 controls the transmission gear 23 to neutral based on the stop request signal, and mechanically disconnects the drive motor 22 and the drive wheels 27. Control of the transmission gear 23 by the gear control unit 33 is executed prior to the execution of stop processing of the high-voltage system 10 after acquisition of the stop request signal.

Further, the gear control unit 33 may acquire a determination result of whether or not the electric vehicle 1 is traveling. Determination of whether or not the vehicle is traveling may be performed by the gear control unit 33. When the electric vehicle 1 is traveling, the gear control unit 33 controls the transmission gear 23 so that transition from the first state to the second state is started after the electric vehicle 1 stops.

The stop processing unit 32 executes stop processing of the high-voltage system 10 based on the stop request signal. As one example, when the stop request signal is acquired by the acquisition unit 31, the stop processing unit 32 executes stop processing of the high-voltage system 10 after waiting for the transmission gear 23 to be controlled to neutral.

Stop processing of the high-voltage system 10 by the stop processing unit 32 includes interruption processing that interrupts the high-voltage system 10 and preparation processing that is executed before interruption of the high-voltage system 10. The interruption processing may be, for example, interruption of a relay in the high-voltage battery 11. The preparation processing may be, for example, processing for stopping the auxiliary equipment 13.

In one example, when the stop request signal is acquired by the acquisition unit 31, the stop processing unit 32 determines whether or not the transmission gear 23 has been controlled to neutral by the gear control unit 33, and executes stop processing of the high-voltage system 10 when the transmission gear 23 is controlled to neutral. This stop processing may be, for example, interruption processing of the high-voltage system 10.

Further, when there is an abnormality in transition from the first state to the second state executed by the gear control unit 33, the stop processing unit 32 may execute stop processing of the high-voltage system 10 without waiting for transition from the first state to the second state. For example, the stop processing unit 32 determines that there is an abnormality in transition from the first state to the second state when transition from the first state to the second state is not completed even after a predetermined time has elapsed. Further, determination of whether or not there is an abnormality in transition from the first state to the second state may be performed by the gear control unit 33.

Further, in a case where transition control from the first state to the second state by the gear control unit 33 is not completed, when a start request signal that requests start of the high-voltage system 10 is acquired, the stop processing unit 32 stops the stop processing and restarts operation of the high-voltage system 10. In this case, the gear control unit 33 stops transition from the first state to the second state in the transmission gear 23.

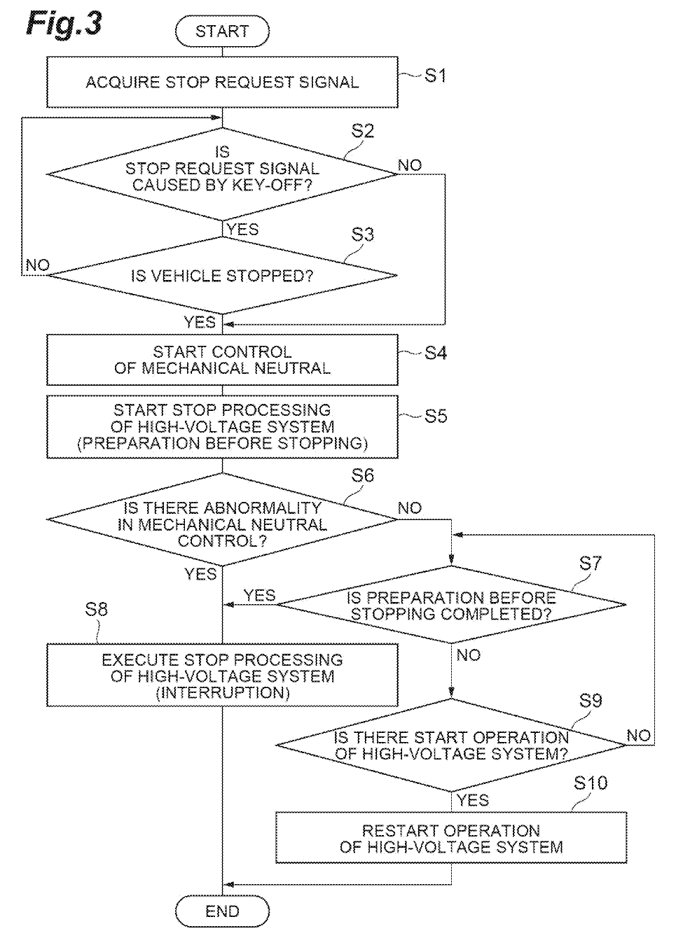

FIG. 3 is a flow diagram showing an example of an operation when the high-voltage system 10 is stopped by the control device 30. In a method of stopping the high-voltage system 10 by the control device 30, first, a stop request signal is acquired by the acquisition unit 31 (step S1). Subsequently, it is determined what the stop request signal is caused by. In the illustrated example, determination is performed by the acquisition unit 31 as to whether or not the stop request signal is based on a key-off operation by a driver (step S2).

In step S2, when it is determined that the stop request signal is caused by key-off, determination is performed as to whether the electric vehicle 1 is in a stopped state or in a traveling state (step S3). When it is determined that the vehicle is stopped, control of mechanical neutral is started (step S4). That is, the gear control unit 33 controls the transmission gear 23 so as to transition from the first state to the second state. On the other hand, when it is determined that the vehicle is traveling, the process returns to step S2 again. In this case, step S2 and step S3 are repeated until the electric vehicle 1 changes from a traveling state to a stopped state.

In step S2, when it is determined that the stop request signal is not caused by key-off, the process proceeds to step S4 without determining whether or not the electric vehicle 1 is stopped. In one example, a stop request signal based on a cause other than key-off may be based on a self-diagnosis function as described above. In this way, when it is necessary to immediately stop the high-voltage system 10, control of mechanical neutral is started regardless of the traveling state of the electric vehicle 1.

Subsequently, stop processing of the high-voltage system 10 is started (step S5). In step S5 of one example, processing of preparation before stopping of the high-voltage system 10 is executed. In step S5, for example, operation of the auxiliary equipment 13 constituting the high-voltage system 10 is stopped, and supply of electric power to the auxiliary equipment 13 is stopped.

Subsequently, determination is performed as to whether or not an abnormality has occurred in control of mechanical neutral started by the gear control unit 33 (step S6). That is, in step S6, it is determined whether or not the transmission gear 23 has transitioned from the first state to the second state and the drive motor 22 and the drive wheels 27 have been mechanically disconnected. When the transmission gear 23 has transitioned to the second state, it is determined that there is no abnormality, and when the transmission gear 23 has not transitioned to the second state, it is determined that there is an abnormality.

When it is determined in step S6 that there is no abnormality, it is determined whether or not preparation before stopping of the high-voltage system 10 has been completed (step S7). When preparation before stopping of the high-voltage system 10 has been completed, the process proceeds to step S8. When preparation before stopping of the high-voltage system 10 has not been completed, determination is performed as to the presence or absence of a start operation of the high-voltage system 10 (step S9). When there is a start operation in step S9, operation of the high-voltage system 10 is restarted (step S10). When there is no start operation, the process returns to step S7. That is, in a stage before preparation before stopping of the high-voltage system 10 is completed, restarting of operation of the high-voltage system 10 is possible.

In step S8, stop processing of the high-voltage system 10 is executed. That is, interruption of the high-voltage system 10 is performed. In one example, by a signal from the stop processing unit 32, interruption of a relay in the high-voltage battery 11 is performed, whereby the high-voltage system 10 is stopped.

As described above, in the present disclosure, the control device 30 that performs control of the electric vehicle 1 is provided. The electric vehicle 1 is provided with the high-voltage system 10, the drive motor inverter 21 that converts electric power from the high-voltage system 10 into an alternating current, the drive motor 22 that is operated by the alternating current supplied from the drive motor inverter 21, and the transmission gear 23 that transmits power of the drive motor 22 to the drive wheels 27. The transmission gear 23 is controllable between a first state in which the drive motor 22 and the drive wheels 27 are mechanically connected and a second state in which the drive motor 22 and the drive wheels 27 are mechanically disconnected. The control device 30 is provided with a processing circuit. The processing circuit acquires a stop request signal that requests stopping of the high-voltage system 10. The processing circuit executes stop processing of the high-voltage system 10 based on the stop request signal. The processing circuit controls the transmission gear 23 so that transition from the first state to the second state is started prior to the execution of stop processing of the high-voltage system 10.

In this control device 30, when stop processing of the high-voltage system 10 is performed, control is performed so that the drive motor 22 and the drive wheels 27 are mechanically disconnected prior to stop processing of the high-voltage system 10. Therefore, even if an error occurs in control of the drive motor inverter 21 and the drive motor 22 operates in a case where stopping of the high-voltage system 10 takes time or the like, transmission of power of the drive motor 22 to the drive wheels 27 is suppressed. Therefore, it is possible to suppress generation of driving force in the vehicle when stopping the high-voltage system 10.

In an example, the processing circuit may execute stop processing of the high-voltage system 10 without waiting for transition from the first state to the second state when there is an abnormality in transition from the first state to the second state. In this configuration, even if a malfunction occurs in the transmission gear 23 or a transmission state control unit, stop processing of the high-voltage system 10 can progress without delay.

In an example, the processing circuit may determine that there is an abnormality in transition from the first state to the second state when transition from the first state to the second state is not completed even after a predetermined time has elapsed. In this configuration, since determination of abnormality is performed by the processing circuit, stop processing of the high-voltage system 10 can proceed without delay.

In an example, the processing circuit may acquire a determination result of whether or not the electric vehicle 1 is traveling, and may control the transmission gear 23 so that transition from the first state to the second state is started after the electric vehicle 1 stops when the electric vehicle 1 is traveling. In this configuration, it is possible to suppress malfunctions due to the drive motor 22 and the drive wheels 27 being mechanically disconnected in the traveling electric vehicle 1.

Although embodiments of the present disclosure have been described above, the present disclosure is not limited to the above embodiments.

For example, although the transmission gear 23 was illustrated as the transmission mechanism, the disclosure is not limited thereto. For example, a clutch may be provided between the drive motor 22 and the differential gear 25, and a mechanical connection state between the motor and the drive wheels may be controlled by controlling the clutch.

As an operation when the high-voltage system 10 is stopped, an example was shown in which the origin of the stop request signal is determined as in steps S2 and S3, but for example, after the stop request signal is acquired in step S1, the process may transition to step S4 without passing through steps S2 and S3.

### REFERENCE SIGNS LIST

1 Electric vehicle, 10 High-voltage system (battery system), 21 Drive motor inverter (inverter), 22 Drive motor (motor), 23 Transmission gear (transmission mechanism), 30 Control device.

What is claimed is:

1. A device for performing control of an electric vehicle, wherein
the electric vehicle is provided with a battery system, an inverter that converts electric power from the battery system into an alternating current, a motor that is operated by the alternating current supplied from the inverter, and a transmission mechanism that transmits power of the motor to drive wheels,
the transmission mechanism is controllable between a first state in which the motor and the drive wheels are mechanically connected and a second state in which the motor and the drive wheels are mechanically disconnected, and
the device is provided with a processing circuit configured to
acquire a stop request signal that requests stopping of the battery system,
execute stop processing of the battery system based on the stop request signal, and
control the transmission mechanism so that transition from the first state to the second state is started prior to the execution of the stop processing of the battery system.

2. The electric vehicle control device according to claim 1, wherein the processing circuit executes the stop processing of the battery system without waiting for transition from the first state to the second state when there is an abnormality in the transition from the first state to the second state.

3. The electric vehicle control device according to claim 2, wherein the processing circuit determines that there is an abnormality in the transition from the first state to the second state when the transition from the first state to the second state is not completed even after a predetermined time has elapsed.

4. The electric vehicle control device according to claim 1, wherein the processing circuit acquires a determination result of whether or not the electric vehicle is traveling, and controls the transmission mechanism so that transition from the first state to the second state is started after the electric vehicle stops when the electric vehicle is traveling.
